(19) United States
(12) Patent Application Publication
(10) Pub. No.: US 2026/0339326 A1
(43) Pub. Date: Oct. 29, 2026

(54) ROBOT, MAPPING METHOD AND APPARATUS FOR ROBOT, AND PROGRAM PRODUCT

(71) Applicant: UBTECH ROBOTICS CORP LTD, Shenzhen (CN)

(72) Inventors: YU TANG, Shenzhen (CN); Simin Zhang, Shenzhen (CN)

(21) Appl. No.: 19/649,353

(22) Filed: Apr. 16, 2026

(30) Foreign Application Priority Data
Apr. 23, 2025 (CN) 202510522091.3

(51) Int. Cl. G05D 1/246; G01S 17/89; G05D 105/80; G05D 109/10; G05D 111/10

(52) U.S. Cl. CPC G05D 1/2464; G01S 17/89; G05D 2105/87; G05D 2109/10; G05D 2111/17

(57) ABSTRACT

The present disclosure relates to the field of robot mapping, and more particularly, to a robot, a mapping method for the robot, and a program product. The method includes: acquiring a current key frame collected by the robot; determining a straight line feature of an obstacle included in a scene according to the current key frame; determining a normal vector that is perpendicular to the straight line feature and matches a current position of the robot; and performing point cloud matching on the current key frame and a historical key frame according to the straight line feature and the normal vector, and constructing a map according to a point cloud matching result of the current key frame and the historical key frame.

### CROSS REFERENCE TO RELATED APPLICATIONS

The present disclosure claims the benefit of priority under the Paris Convention to Chinese Patent Application 202510522091.3, filed on Apr. 23, 2025, which is incorporated herein by reference in its entirety.

### TECHNICAL FIELD

The present disclosure generally relates to the field of robot mapping, and more particularly, to a robot, a mapping method and apparatus for the robot, and a program product.

### BACKGROUND

Since maps are a prerequisite for a robot to perform autonomous localization, path planning, and navigation, constructing an accurate large-scale environmental map is an important prerequisite for the robot's intelligence, and an accurate map enables the robot to achieve more accurate localization, more reasonable path planning, and safer navigation. Mapping is the process of establishing a continuous and consistent scene map of a surrounding environment based on estimation of the robot's motion. In this process, simultaneous localization and mapping (SLAM) plays a crucial role, as SLAM not only helps the robot understand the environment but also enables precise localization and navigation.

However, in the mapping process, objects with large size and similar structural features, such as walls, are often encountered. The robot tends to suffer from mislocalization of wall positions during mapping, which is unfavorable for improving the accuracy of mapping and, in turn, affects the robot's overall intelligent performance.

### BRIEF DESCRIPTION OF DRAWINGS

To further clarify the technical solutions in the embodiments of the present disclosure, the following provides a brief introduction to the accompanying drawings referenced in the description of the embodiments or existing technologies. It is evident that the accompanying drawings described below are merely some embodiments of the present disclosure, and those skilled in the art can derive additional drawings based on these accompanying drawings without creative effort.

FIG. 1 is a schematic diagram of a mapping effect of a robot at an N^{th} moment according to an embodiment of the present disclosure.

FIG. 2 is a schematic diagram of a correct mapping effect of a robot at an (N+1)^{th} moment according to an embodiment of the present disclosure.

FIG. 3 is a schematic diagram of an erroneous matching effect of a robot at an (N+1)^{th} moment according to an embodiment of the present disclosure.

FIG. 4 is another schematic diagram of an erroneous matching effect of a robot at an (N+1)^{th} moment according to an embodiment of the present disclosure.

FIG. 5 is a schematic flowchart of an implementation of a mapping method for a robot according to an embodiment of the present disclosure.

FIG. 6 is a schematic flowchart of an implementation of a method according to an embodiment of the present disclosure.

FIG. 7 is a schematic diagram of a normal vector direction according to an embodiment of the present disclosure.

FIG. 8 is a schematic diagram of a normal vector of a point cloud detected by a robot at an entrance of a room according to an embodiment of the present disclosure.

FIG. 9 is a schematic diagram of a mapping apparatus of a robot according to an embodiment of the present disclosure.

FIG. 10 is a schematic diagram of a robot according to an embodiment of the present disclosure.

### DETAILED DESCRIPTION

For the purpose of illustration and not limitation, specific details such as particular system structures and technologies are provided to facilitate a thorough understanding of the embodiments of the present disclosure. However, those skilled in the art should appreciate that the present disclosure can be implemented in other embodiments without these specific details. In other cases, detailed descriptions of well-known systems, devices, circuits, and methods are omitted to avoid unnecessary details that may obscure the description of the present disclosure.

To illustrate the technical solution disclosed in the present disclosure, the following embodiments are provided.

Maps are the foundation for a robot to achieve autonomous localization, path planning, and navigation. Constructing an accurate large-scale environmental map is an important prerequisite for the robot's intelligence, because an accurate map enables the robot to achieve more precise localization, more reasonable path planning, and safer and more reliable navigation.

Mapping is the process of establishing a continuous and consistent scene map of a surrounding environment based on an estimation of the robot's motion. In this process, simultaneous localization and mapping (SLAM) plays a key role. SLAM not only helps the robot understand the environment but also enables precise localization and navigation. However, mapping mismatch may introduce a series of issues that affect the performance of the SLAM system. To improve the accuracy and reliability of SLAM, techniques such as filtering and optimization algorithms are typically employed to reduce the impact of mismatch.

Nevertheless, in actual mapping processes, the robot often encounters objects of large size with similar structural features, such as walls. These objects tend to cause the robot misjudge wall positions during mapping, thereby reducing the accuracy of mapping and, in turn, affecting the overall intelligent performance of the robot.

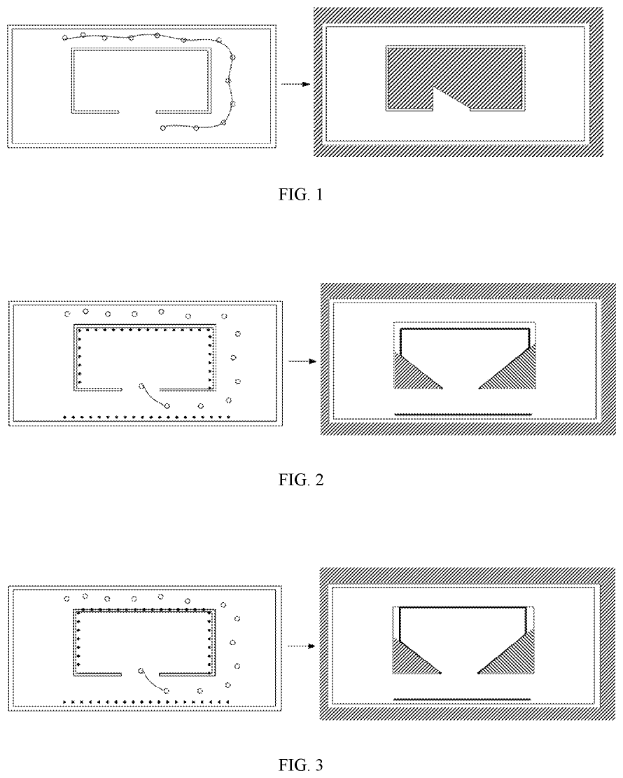

As shown in FIG. 1, which is a schematic diagram of a mapping effect of a robot at an N^{th} moment. In the left portion of FIG. 1, the robot moves along the trajectory shown in the figure to a position at the right side of an entrance of a rectangular room, during which a plurality of key frames are collected. A grid map formed at this moment is shown in the right portion of FIG. 1, where the black region denotes obstacles, the hatching region denotes unknown areas, and the white region denotes free space.

As shown in FIG. 2, which is a schematic diagram of a correct mapping effect of the robot at an (N+1)^{th} moment. At the (N+1)^{th} moment, the robot is located at the entrance of the rectangular room, as shown in the left portion of FIG. 2. The robot detects wall point clouds inside the room, performs correct matching on the detected wall point clouds and point clouds of a historical key frame, and determines that the matched point clouds after the matching between the current key frame and the historical key frame include the point clouds on the interior side of the walls. After converting a point cloud map to a grid map, the grid map as shown in the right portion of FIG. 2 is obtained, in which an accurate obstacle grid is formed on the interior side of the walls of the rectangular room.

As shown in FIG. 3, which is a schematic diagram of an erroneous matching effect of the robot at an (N+1)^{th} moment. At the (N+1)^{th} moment, the robot is located at the entrance of the rectangular room, as shown in the left portion of FIG. 3. After performing point cloud matching, because the walls are relatively thin, the interior-side point clouds of the wall facing the room entrance are close to the exterior-side point clouds of the wall facing the room entrance, causing mismatching between the interior-side and exterior-side point clouds. The matched point clouds are located on the exterior side of the wall, and an obstacle grid is formed on the wall directly facing the room entrance after the point cloud map is converted to the grid map, resulting in a deviation from a position of a correct obstacle grid.

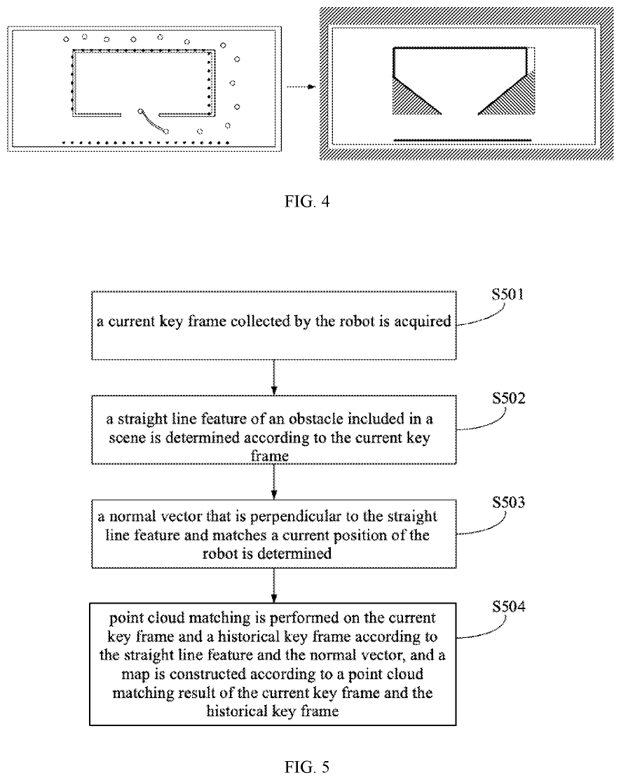

As shown in FIG. 4, which is another schematic diagram of an erroneous matching effect of the robot at the (N+1)^{th} moment. At the (N+1)^{th} moment, the robot is located at the entrance of the rectangular room, as shown in the left portion of FIG. 4. After performing point cloud matching, because the walls are relatively thin, the interior-side point clouds of the wall facing the room entrance are close to the exterior-side point clouds of the wall facing the room entrance and the interior-side point clouds of the left wall are close to the exterior-side point clouds of the left wall, causing mismatching between the interior-side and exterior-side point clouds. The matched point clouds are located on the exterior sides of the walls, and obstacle grids are formed on the exterior side of the wall facing the room entrance and on the exterior side of the left wall after the point cloud map is converted to the grid map, resulting in a deviation from positions of correct obstacle grids.

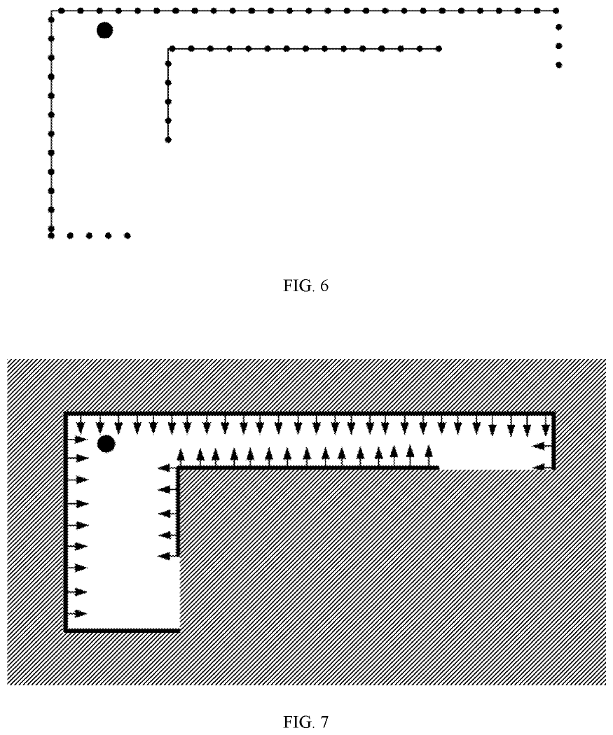

To address the above issues, an embodiment of the present disclosure provides a mapping method for a robot, as shown in FIG. 5, including the following operations.

At operation S501, a current key frame collected by the robot is acquired.

The robot in the embodiment of the present disclosure may be a smart device with autonomous mobility and capable of perceiving the surrounding environment via mounted sensors and performing autonomous localization, path planning, and mapping according to a preset algorithm, such as common household sweeping robots, logistics delivery robots, etc. When the robot collects the key frame, it may use mounted sensors (e.g., LiDAR) to collect data on the surrounding environment. LiDAR works by emitting laser beams and receiving reflected light to measure distances to surrounding objects, thereby obtaining geometric information of the environment.

In the embodiment of the present disclosure, the key frame is a laser frame collected during the robot's movement according to a certain rule (e.g., after moving a certain distance or rotating by a certain angle) for mapping. The key frame serves to reduce data processing load and filter out some erroneous data. For example, when the robot has moved forward by 0.5 meters or rotated by 30 degrees, a new key frame may be added. The current key frame refers to a key frame collected at the current moment.

At operation S502, a straight line feature of an obstacle included in a scene is determined according to the current key frame.

Features of the obstacle in the scene where the robot is located may include contour features such as a curve feature and a straight line feature. Since the curve feature contains more descriptive information and is less prone to mismatch during matching, the embodiment of the present disclosure focuses on describing the straight line features of obstacles that occur frequently in daily life. For example, in an office scenario, there is one or more rooms, and each room is delineated from the office space by walls.

The embodiment of the present disclosure may employ a linear detection algorithm such as a least-square method to fit straight line features in laser point cloud data. For example, as shown in FIG. 6, after acquiring laser point cloud data by LiDAR, the laser point cloud data may be fitted to a straight line by the least-square method. FIG. 6 includes a plurality of laser point cloud data, from which a plurality of straight lines may be obtained. For the laser point cloud data in a key frame, coordinates of these points are substituted into a mathematical model of the least-square method to compute parameters of a best-fit straight line, including, for example, the slope and intercept. Assume that in a key frame the LiDAR scans a wall, the point cloud data may be approximately distributed along a single straight line. After fitting by the least-square method, an equation of this straight line may be AX+BY+C=0, where A, B and C are the fitted parameters, and this straight line is the straight line feature of the wall obstacle.

At operation S503, a normal vector that is perpendicular to the straight line feature and matches a current position of the robot is determined.

After the straight line feature of the obstacle is determined, the normal vector that is perpendicular to the straight line feature is computed according to the equation of the straight line feature. For example, for the straight line equation AX+BY+C=0, a normal vector may be taken as ±(A, B). The normal vector includes vectors in two directions. To enable accurate point cloud matching, embodiments of the present disclosure determine the direction of the normal vector according to a specific rule. To ensure that the normal vector matches the current position of the robot, a direction of the normal vector oriented towards the side where the robot is located may be determined as the direction of the normal vector, or a direction of the normal vector oriented away from the side where the robot is located may be determined as the direction of the normal vector.

For example, as shown in FIG. 7, which is a schematic diagram of a normal vector direction, when the robot is moving in a corridor, if the direction of the normal vector direction is set to a direction oriented towards the side where the robot is located, a normal vector of a point cloud determined in the key frame collected by the robot at the corridor position, or a normal vector of a grid corresponding to the point cloud, is the normal vector oriented towards the corridor.

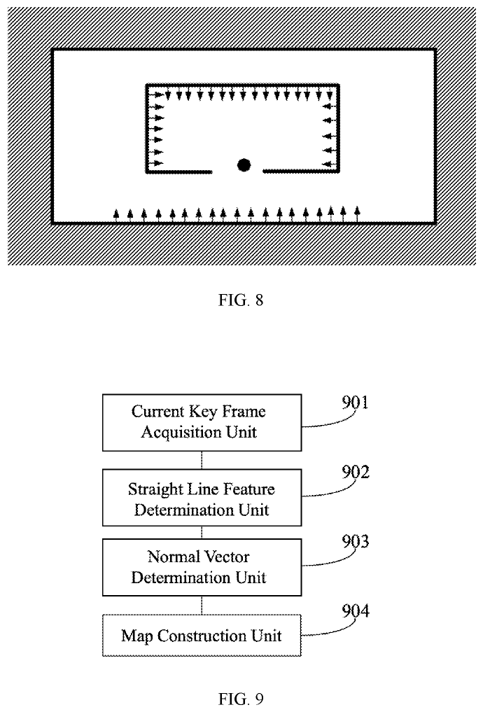

As shown in FIG. 8, which is a schematic diagram of a normal vector of a point cloud detected by a robot at an entrance of a room. When the robot is at the entrance of the room, the normal vector determined by the laser point cloud data collected by the robot at this position is a normal vector in a direction oriented towards a position where the robot is. As shown in FIG. 8, a direction of the normal vector of the laser point cloud data inside the room is towards the interior of the room, whereas a direction of the normal vector of the laser point cloud data at the bottom region outside the room is towards the upper of the side where the robot is located.

In the embodiments of the present disclosure, since the determined direction of the normal vector may not precisely point to the position of the robot, the normal vector corresponding to the position of the robot may be determined based on an included angle. For example, the included angle may be determined between a ray from the point cloud or grid toward the robot and the normal vector. If the included angle is less than 90 degrees, the current direction of the normal vector is oriented towards a side where the robot is located. If the included angle is greater than 90 degrees, the current direction of the normal vector is oriented away from the side where the robot is located. For example, directions of the normal vector determined in FIG. 7 and FIG. 8 are both oriented towards the side where the robot is located.

At operation S504, point cloud matching is performed on the current key frame and a historical key frame according to the straight line feature and the normal vector, and a map is constructed according to a point cloud matching result of the current key frame and the historical key frame.

In the embodiments of the present disclosure, historical key frames may be key frames collected earlier for mapping during the robot's motion prior to the current time, which already include a portion of information of the constructed map. During the point cloud matching, the point cloud data of the current key frame is compared and aligned with the point cloud data of the historical key frame to establish their spatial correspondence and determine pose change parameters, thereby determining position changes of the robot within the map and the continuity of the environment. Based on the point cloud matching result, the environmental information in the current key frame is integrated into an existing map, thereby forming a continuous and consistent scene map through map construction.

During the point cloud matching, a feature-and-normal-vector based point cloud matching method may be employed, leveraging the previously extracted straight line feature and the determined normal vector to assist the matching process.

For example, in the current key frame and the historical key frame, a first straight line feature of an obstacle in the current key frame, a first normal vector corresponding to the first straight line feature, a second straight line feature of an obstacle in the historical key frame, and a second normal vector corresponding to the second straight line feature are extracted respectively. By comparing the similarity of these straight line features and the directional consistency of the normal vectors, a relative pose (position and attitude) relationship between the two key frames is determined. Assume that a straight line feature of a wall is detected in both the current key frame and a historical key frame, and their normal vectors (the first normal vector and the second normal vector) have consistent directions, then it may be preliminarily concluded that the walls in the two key frames are the same wall observed from different positions, and the movement and rotation parameters of the robot from the historical key frame to the current key frame may be calculated based on their straight line features and normal vectors.

If the directions of the first normal vector and the second normal vector are not consistent, the walls in the two key frames may be the same wall observed from different sides, in which case the point cloud matching between the point cloud corresponding to the first straight line feature in the current key frame and the point cloud corresponding to the second straight line feature in the historical key frame may be rejected.

In one possible implementation, if both sides of the wall are not parallel, an included angle between the first normal vector and the second normal vector may be determined. If this included angle is less than a predetermined included angle threshold, e.g., less than 90 degrees, it is determined that the first normal vector matches the second normal vector, indicating that the walls in the two key frames are the same wall observed from different positions. If the included angle is greater than or equal to the predetermined included angle threshold, e.g., greater than or equal to 90 degrees, it is determined that the first normal vector does not match the second normal vector.

During the matching calculation, the straight line equation of the straight line feature may be determined according to the matched normal vector of the current position of the robot.

If the current position of the robot is on a first side, its normal vector is (A, B). According to a matching rule of the normal vector, the determined straight line equation of the straight line feature may be AX+BY+C=0. If the current position of the robot is on a second side, the normal vector is −(A, B). According to the matching rule of the normal vector, the determined straight line equation of the straight line feature of the current key frame may be −AX−BY−C=0.

Based on the determined straight line equation, an error function for matching between the current key frame and the historical key frame may be determined. If the determined straight line equation of the straight line feature is AX+BY+C=0, the error function may be expressed as:

$$E = {\sum }_{i = 1}^{n} \{ \begin{matrix}{Ax}_{i} + {By}_{i} + C , & {Ax}_{i} + {By}_{i} + C > 0 \\ 0 , & {Ax}_{i} + {By}_{i} + C \leq 0\end{matrix}$$

where E denotes an error of the error function, Xᵢ, Yᵢ denote the coordinates of an i^{th} point cloud, n denotes the number of point clouds, and A, B, C denote the parameters of the straight line equation.

A first-degree polynomial AX+BY+C may be determined from the straight line equation. The coordinates of the point cloud in the historical key frame are substituted into the first-degree polynomial, and a calculation value of the first-degree polynomial is computed from the parameters A, B, C of the first-degree polynomial. The calculation value is compared with a predetermined value, and whether the calculation value is allowed to contribute to the error is determined based on the comparison result.

For example, the calculation value is compared with 0. If the direction oriented towards the side on which the robot is located is determined as the direction of the normal vector, the calculation value of the first-degree polynomial corresponding to the point cloud is allowed to be included in the error when the calculation value is greater than 0, and the calculation value of the first-degree polynomial corresponding to the point cloud is rejected from being included in the error when the calculation value is less than or equal to 0.

Based on changes in the value of included in the error, an optimization method may be adopted, including gradient descent, Gauss-Newton, etc., to adjust a pose of the current key frame and optimize the parameters in the error function so as to minimize the error, or to perform a preset number of optimization iterations to obtain the optimized error.

A local point cloud of the current key frame of the robot is converted to a global coordinate system according to the optimized pose corresponding to the current key frame of the robot, thereby obtaining the map after the point cloud matching.

The embodiments of the present disclosure enable mapping without adding additional sensors and reduce the mapping mismatch of the robot through normal vector matching, thereby improving the accuracy of mapping and the intelligence performance of the robot.

It should be understood that the size of sequence numbers of the operations described in the above embodiments does not imply a specific order of execution. The execution order of each process should be determined by its functionality and inherent logic, which should not impose any limitations on the implementation process of the embodiments of the present disclosure.

FIG. 9 is a schematic diagram of a mapping apparatus for a robot according to an embodiment of the present disclosure. The mapping apparatus includes: a current key frame acquisition unit 901, configured to acquire a current key frame collected by the robot; a straight line feature determination unit 902, configured to determine a straight line feature of an obstacle included in a scene according to the current key frame; a normal vector determination unit 903, configured to determine a normal vector that is perpendicular to the straight line feature and matches a current position of the robot; and a map construction unit 904, configured to perform point cloud matching on the current key frame and a historical key frame according to the straight line feature and the normal vector, and construct a map according to a point cloud matching result of the current key frame and the historical key frame.

The mapping apparatus for the robot shown in FIG. 9 corresponds to the mapping method for the robot shown in FIG. 5.

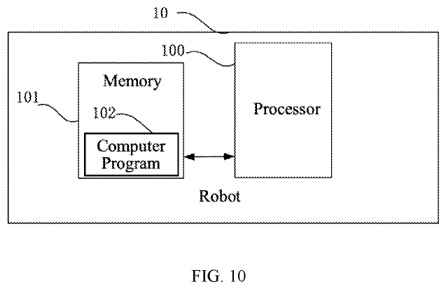

FIG. 10 is a schematic diagram of a robot according to an embodiment of the present disclosure. As shown in FIG. 10, the robot 10 of the embodiment includes: a processor 100, a memory 101, and a computer program 102 (such as the mapping program of the robot) stored in the memory 101 and executable on the processor 100. The processor 100 executes the computer program 102 to implement the operations in any of the mapping method embodiments for the robot described above. Alternatively, the processor 100 executes the computer program 102 to implement functions of each module/unit in the apparatus embodiments described above.

For example, the computer program 102 may be divided into one or more modules/units, and the one or more modules/units are stored in the memory 101 and executed by the processor 100 to complete the present disclosure. The one or more modules/units may be a series of computer program instruction segments capable of performing specific functions, which are used to describe the execution process of the computer program 102 in the robot 10.

The robot includes, but is not limited to, the processor 100, and the memory 101. Those skilled in the art should understand that FIG. 10 is merely an example of the robot 10 and does not limit the robot 10. The robot may include more or fewer components than those illustrated, or combinations of certain components, or different components, such as input/output devices, network access devices, buses, etc.

The processor 100 may be a central processing unit (CPU), or may be other general-purpose processors, digital signal processors (DSP), application specific integrated circuits (ASIC), field-programmable gate arrays (FPGA) or other programmable logic devices, discrete gates or transistor logic devices, or discrete hardware components, etc. The general-purpose processor may be a microprocessor or any conventional processor.

In some embodiments, the memory 101 may be an internal storage unit of the robot 10, such as a hard disk or memory of the robot 10. In other embodiments, the memory 101 may also be an external storage device of the robot 10, such as a plug-in hard drive, smart media card (SMC), secure digital (SD) card, flash card, etc. equipped on the robot 10. Furthermore, the memory 101 may include both the internal storage unit of the robot 10 and the external storage device of the robot 10. The memory 101 is configured to store the computer program as well as other program and data required by the robot. The memory 101 may further be configured to temporarily store data that has been output or is to be output.

Those skilled in the art may clearly understand that, for the sake of convenience and brevity in description, the division of the above functional units and modules is merely illustrative. In practical applications, the above functions may be allocated to and accomplished by different functional units or modules as needed. That is, an internal structure of the apparatus may be divided into different functional units or modules to accomplish all or part of the functions described above. The functional units and modules in the embodiments may be integrated into a single processing unit, or each unit may exist physically independently, or two or more units may be integrated into one unit. The integrated units may be realized in the form of hardware or in the form of software functional units. Furthermore, specific names of the functional units and modules are only for the purpose of facilitating mutual distinction and do not limit the protection scope of the present disclosure. The specific working processes of the units and modules in the above system may refer to the corresponding processes in the previously mentioned method embodiments and are not reiterated here.

In the above embodiments, the descriptions of each embodiment have their own focus. Parts that are not detailed or recorded in one embodiment can refer to the relevant descriptions of other embodiments.

Those skilled in the art should recognize that the units and algorithm operations described in the examples disclosed herein can be implemented in electronic hardware, or in a combination of computer software and electronic hardware. Whether these functions are executed in hardware or software depends on the specific application of the technical solution and design constraints. Those skilled in the art may use different methods to implement the described functions for each specific application. However, such implementations should not be considered beyond the scope of the present disclosure.

In the embodiments provided in the present disclosure, it should be understood that the disclosed apparatuses/robots and methods may be implemented in other ways. For example, the apparatuses/robots described above are merely illustrative, e.g., the division of modules or units is only one logical functional division. In actual implementation, there may be other ways of division, such as a plurality of units or components being combined or integrated into another system, or some features being omitted or not executed. Additionally, the coupling, direct coupling, or communication connections shown or discussed may be through certain interfaces, and the indirect coupling or communication connections between devices or units may be electrical, mechanical, or in other forms.

The units described as separate components may or may not be physically separated. The components displayed as units may or may not be physical units, i.e., may be located in one place or distributed across a plurality of network units. Portions or all of the units may be selected as needed to achieve the objectives of the embodiments of the present disclosure.

In addition, the functional units in each embodiment of the present disclosure may be integrated into a processing unit, or each unit may exist physically separately, or two or more units may be integrated into one unit. The above integrated unit may be implemented either in the form of hardware or in the form of software functional units.

The integrated module/unit may be stored in a computer-readable storage medium if implemented in the form of a software functional unit and sold or used as a standalone product. Based on such understanding, the implementation of all or part of the processes in the above method embodiments may be accomplished by instructing the relevant hardware through a computer program. The computer program is able to be stored in a computer-readable storage medium which, when executed by a processor, implements the operations of the various method embodiments described above. The computer program includes a computer program code, which may be in the form of source code, object code, executable files, or certain intermediate forms. The computer-readable storage medium may include at least: any entity or device capable of carrying the computer program code, recording media, USB drives, portable hard disks, magnetic disks, optical discs, computer memory, read-only memory (ROM), random access memory (RAM), electrical carrier signals, telecommunication signals, and software distribution media. It should be noted that the content included in the computer-readable medium may be appropriately increased or decreased in accordance with the requirements of legislation and patent practice in the jurisdiction. For example, in some jurisdictions, according to legislation and patent practice, the computer-readable medium does not include carrier signals and telecommunication signals.

In addition, an embodiment of the present disclosure further provides a computer program product, which, when running on a computer, enables the computer to perform the methods in each of the above implementations.

The above embodiments are intended to illustrate but not to limit the technical solutions of the present disclosure. Although the present disclosure has been described in detail with reference to the above embodiments, those skilled in the art should understand that modifications can still be made to the technical solutions described in the above embodiments, or equivalent substitutions can be made for some of the technical features therein. Such modifications or substitutions do not depart from the spirit and scope of the technical solutions of the embodiments of the present disclosure and should be included within the protection scope of the present disclosure.

What is claimed is:

1. A mapping method for a robot, comprising:
acquiring a current key frame collected by the robot;
determining a straight line feature of an obstacle included in a scene according to the current key frame;
determining a normal vector that is perpendicular to the straight line feature and matches a current position of the robot; and
performing point cloud matching on the current key frame and a historical key frame according to the straight line feature and the normal vector, and constructing a map according to a point cloud matching result of the current key frame and the historical key frame.

2. The mapping method according to claim 1, wherein performing the point cloud matching on the current key frame and the historical key frame according to the straight line feature and the normal vector includes:
determining a vector matching result of a first normal vector of a first straight line feature of the current key frame and a second normal vector of a second straight line feature of the historical key frame;
in response to the first normal vector matching the second normal vector, allowing the point cloud matching between a point cloud corresponding to the first straight line feature of the current key frame and a point cloud corresponding to the second straight line feature of the historical key frame; and
in response to the first normal vector not matching the second normal vector, rejecting the point cloud matching between the point cloud corresponding to the first straight line feature of the current key frame and the point cloud corresponding to the second straight line feature of the historical key frame.

3. The mapping method according to claim 2, wherein determining the vector matching result of the first normal vector of the first straight line feature of the current key frame and the second normal vector of the second straight line feature of the historical key frame includes:
acquiring an included angle between the first normal vector of the first straight line feature of the current key frame and the second normal vector of the second straight line feature of the historical key frame; and
in response to the included angle being less than a predetermined included angle threshold, determining that the first normal vector matches the second normal vector, and in response to the included angle being greater than or equal to the predetermined included angle threshold, determining that the first normal vector does not match the second normal vector.

4. The mapping method according to claim 1, wherein determining the normal vector that is perpendicular to the straight line feature and matches the current position of the robot includes:
determining a normal vector perpendicular to the straight line feature and oriented towards a side on which the robot is located as the normal vector matching the current position of the robot.

5. The mapping method according to claim 1, wherein determining the normal vector that is perpendicular to the straight line feature and matches the current position of the robot includes:
determining a normal vector perpendicular to the straight line feature and oriented away from the side on which the robot is located as the normal vector matching the current position of the robot.

6. The mapping method according to claim 1, wherein performing the point cloud matching on the current key frame and the historical key frame according to the straight line feature and the normal vector, and constructing the map according to the point cloud matching result of the current key frame and the historical key frame includes:
determining a straight line equation of the straight line feature according to the normal vector matching the current position of the robot, and determining an error function for matching between the current key frame and the historical key frame according to the straight line equation;
adjusting a pose parameter of the current key frame such that the error function converges to obtain the point cloud matching result of the current key frame and the historical key frame; and
constructing the map according to the point cloud matching result.

7. The mapping method according to claim 6, wherein determining the error function for the matching between the current key frame and the historical key frame according to the straight line equation includes:
determining a first-degree polynomial according to the straight line equation;
substituting coordinates of a point cloud in the historical key frame into the first-degree polynomial, and determining, according to a comparison result between a calculation value of the first-degree polynomial for the coordinates of the point cloud and a predetermined value, whether the calculation value of the first-degree polynomial for the point cloud is allowed to be included in an error; and
determining the error function according to a sum value of the calculation value that is allowed to be included in the error.

8. The mapping method according to claim 7, wherein a normal vector perpendicular to the straight line feature and oriented towards a side on which the robot is located is determined as the normal vector matching the current position of the robot; and substituting the coordinates of the point cloud in the historical key frame into the first-degree polynomial, and determining, according to the comparison result between the calculation value of the first-degree polynomial for the coordinates of the point cloud and the predetermined value, whether the calculation value of the first-degree polynomial for the point cloud is allowed to be included in the error includes:
substituting the coordinates of the point cloud in the historical key frame into the first-degree polynomial, allowing the calculation value of the first-degree polynomial for the point cloud to be included in the error in response to the calculation value of the first-degree polynomial for the coordinates of the point cloud being greater than 0, and rejecting the calculation value of the first-degree polynomial for the point cloud to be included in the error in response to the calculation value of the first-degree polynomial for the coordinates of the point cloud being less than or equal to 0.

9. A robot, comprising a memory, a processor, and a computer program stored in the memory and executable on the processor, wherein the processor, when executing the computer program, causes the robot to implement a mapping method for a robot; wherein the mapping method includes:
acquiring a current key frame collected by the robot;
determining a straight line feature of an obstacle included in a scene according to the current key frame;
determining a normal vector that is perpendicular to the straight line feature and matches a current position of the robot; and
performing point cloud matching on the current key frame and a historical key frame according to the straight line feature and the normal vector, and constructing a map according to a point cloud matching result of the current key frame and the historical key frame.

10. The robot according to claim 9, wherein performing the point cloud matching on the current key frame and the historical key frame according to the straight line feature and the normal vector includes:
determining a vector matching result of a first normal vector of a first straight line feature of the current key frame and a second normal vector of a second straight line feature of the historical key frame;
in response to the first normal vector matching the second normal vector, allowing the point cloud matching between a point cloud corresponding to the first straight line feature of the current key frame and a point cloud corresponding to the second straight line feature of the historical key frame; and
in response to the first normal vector not matching the second normal vector, rejecting the point cloud matching between the point cloud corresponding to the first straight line feature of the current key frame and the point cloud corresponding to the second straight line feature of the historical key frame.

11. The robot according to claim 10, wherein determining the vector matching result of the first normal vector of the first straight line feature of the current key frame and the second normal vector of the second straight line feature of the historical key frame includes:
acquiring an included angle between the first normal vector of the first straight line feature of the current key frame and the second normal vector of the second straight line feature of the historical key frame; and
in response to the included angle being less than a predetermined included angle threshold, determining that the first normal vector matches the second normal vector, and in response to the included angle being greater than or equal to the predetermined included angle threshold, determining that the first normal vector does not match the second normal vector.

12. The robot according to claim 9, wherein determining the normal vector that is perpendicular to the straight line feature and matches the current position of the robot includes:
determining a normal vector perpendicular to the straight line feature and oriented towards a side on which the robot is located as the normal vector matching the current position of the robot.

13. The robot according to claim 9, wherein determining the normal vector that is perpendicular to the straight line feature and matches the current position of the robot includes:
determining a normal vector perpendicular to the straight line feature and oriented away from the side on which the robot is located as the normal vector matching the current position of the robot.

14. The robot according to claim 9, wherein performing the point cloud matching on the current key frame and the historical key frame according to the straight line feature and the normal vector, and constructing the map according to the point cloud matching result of the current key frame and the historical key frame includes:
determining a straight line equation of the straight line feature according to the normal vector matching the current position of the robot, and determining an error function for matching between the current key frame and the historical key frame according to the straight line equation;
adjusting a pose parameter of the current key frame such that the error function converges to obtain the point cloud matching result of the current key frame and the historical key frame; and
constructing the map according to the point cloud matching result.

15. The robot according to claim 14, wherein determining the error function for the matching between the current key frame and the historical key frame according to the straight line equation includes:
determining a first-degree polynomial according to the straight line equation;
substituting coordinates of a point cloud in the historical key frame into the first-degree polynomial, and determining, according to a comparison result between a calculation value of the first-degree polynomial for the coordinates of the point cloud and a predetermined value, whether the calculation value of the first-degree polynomial for the point cloud is allowed to be included in an error; and
determining the error function according to a sum value of the calculation value that is allowed to be included in the error.

16. The robot according to claim 15, wherein a normal vector perpendicular to the straight line feature and oriented towards a side on which the robot is located is determined as the normal vector matching the current position of the robot; and
substituting the coordinates of the point cloud in the historical key frame into the first-degree polynomial, and determining, according to the comparison result between the calculation value of the first-degree polynomial for the coordinates of the point cloud and the predetermined value, whether the calculation value of the first-degree polynomial for the point cloud is allowed to be included in the error includes:
substituting the coordinates of the point cloud in the historical key frame into the first-degree polynomial, allowing the calculation value of the first-degree polynomial for the point cloud to be included in the error in response to the calculation value of the first-degree polynomial for the coordinates of the point cloud being greater than 0, and rejecting the calculation value of the first-degree polynomial for the point cloud to be included in the error in response to the calculation value of the first-degree polynomial for the coordinates of the point cloud being less than or equal to 0.

17. A computer program product comprising a computer program, wherein the computer program, when executed, implements a mapping method for a robot; wherein the mapping method includes:
acquiring a current key frame collected by the robot;
determining a straight line feature of an obstacle included in a scene according to the current key frame;
determining a normal vector that is perpendicular to the straight line feature and matches a current position of the robot; and
performing point cloud matching on the current key frame and a historical key frame according to the straight line feature and the normal vector, and constructing a map according to a point cloud matching result of the current key frame and the historical key frame.

18. The computer program product according to claim 17, wherein performing the point cloud matching on the current key frame and the historical key frame according to the straight line feature and the normal vector includes:
determining a vector matching result of a first normal vector of a first straight line feature of the current key frame and a second normal vector of a second straight line feature of the historical key frame;
in response to the first normal vector matching the second normal vector, allowing the point cloud matching between a point cloud corresponding to the first straight line feature of the current key frame and a point cloud corresponding to the second straight line feature of the historical key frame; and
in response to the first normal vector not matching the second normal vector, rejecting the point cloud matching between the point cloud corresponding to the first straight line feature of the current key frame and the point cloud corresponding to the second straight line feature of the historical key frame.

19. The computer program product according to claim 18, wherein determining the vector matching result of the first normal vector of the first straight line feature of the current key frame and the second normal vector of the second straight line feature of the historical key frame includes:
acquiring an included angle between the first normal vector of the first straight line feature of the current key frame and the second normal vector of the second straight line feature of the historical key frame; and
in response to the included angle being less than a predetermined included angle threshold, determining that the first normal vector matches the second normal vector, and in response to the included angle being greater than or equal to the predetermined included angle threshold, determining that the first normal vector does not match the second normal vector.

20. The computer program product according to claim 17, wherein determining the normal vector that is perpendicular to the straight line feature and matches the current position of the robot includes:
determining a normal vector perpendicular to the straight line feature and oriented towards a side on which the robot is located as the normal vector matching the current position of the robot.
